(19) United States
(12) Patent Application Publication
(10) Pub. No.: US 2008/0316188 A1
(43) Pub. Date: Dec. 25, 2008

(54) LIQUID CRYSTAL DISPLAY COMPRISING DRIVING CIRCUIT UNIT

(75) Inventors: Yong Beom Kim, Bupyeong-Gu (KR); Woon Yong Park, Paldal-Gu (KR); Kyu Yeol Kim, Wonmi-Gu (KR)

Correspondence Address: GA-KYUNG INTERNATIONAL PATENT & LAW OFFICE;4TH FLOOR YENSU BLDG., 1149 GUWEOL-1, DONG, NAMDONG-GU, INCHEON, KR

(73) Assignee: TOVIS Co., Ltd., Wonju-City (KR)

(21) Appl. No.: 11/765,844

(22) Filed: Jun. 20, 2007

(51) Int. Cl. G09G 5/00

(52) U.S. Cl. 345/204

(57) ABSTRACT

There is provided a liquid crystal display comprising a driving circuit unit. The driving circuit unit has an adaptor and an inverter for converting an input voltage integrally configured with each other. Thus, the liquid crystal display is made small. The liquid crystal display can stably and efficiently display an image through a smaller liquid crystal when an external voltage is supplied to each circuit.

### BACKGROUND OF THE INVENTION

1. Technical Field

The present invention relates to a liquid crystal display comprising a driving circuit unit, and more particularly, to a liquid crystal display comprising a driving circuit unit having an adaptor and an inverter for converting an input voltage integrally configured with each other, and an LCD module having an LED module and an LED drive, thereby making the liquid crystal display suitable as a small or middle-sized liquid crystal display and stably and efficiently displaying an image.

2. Discussion of Related Art

In general, a liquid crystal display (LCD) has bee used to display an image from a computer. With the recent development of technology, an LCD television has been developed.

The liquid crystal display has been used as a monitor for a desktop computer, and a portable computer such as a notebook computer. Recently, the liquid crystal display is applied to a variety of consumer electronic appliances such as portable phones, refrigerators, televisions, and washing machines.

A liquid crystal display displays an image through molecule arrangement of liquid crystals changing as a voltage is supplied to pixels. The liquid crystal display itself cannot emit light and be used at dark places. For use at dark places, the liquid crystal display comprises a back light lamp for surface-illuminating an information display panel in a uniform manner.

As the liquid crystal display comprises the back light lamp, a power source is necessary. The power source includes a commercial voltage of 220V widely used at homes, and a charged voltage of a rechargeable battery.

However, a voltage on the order of 1000 to 1500V is required for driving the back light lamp. To this end, a separate adaptor converts such a high voltage into a low voltage, and an inverter converts the low voltage into a high AC voltage.

FIG. 1 is a schematic view illustrating a structure of a conventional liquid crystal display, and FIG. 2 is a block diagram illustrating a conventional liquid crystal display.

Referring to FIGS. 1 and 2, first, a power line 110 is provided for taking and supplying an external voltage, and an adaptor 120 for converting an AC voltage into a DC voltage is connected to the power line 110. An interface substrate 140 comprising a signal processing unit 142 for processing an image signal is connected to the adaptor 120. An inverter 160 is connected to the interface substrate 140. The inverter 160 converts a DC voltage from the interface substrate 140 into an AC voltage having a desired size and frequency.

Meanwhile, a power connector 180 is connected to the inverter 160.

The power connector 180 is for supplying the AC voltage from the inverter 160 to back light lamps 202, which are mounted on and beneath a liquid crystal display module 200.

A circuit of such a liquid crystal display will now be described with reference to FIG. 2. First, the liquid crystal display comprises an adaptor 120 for taking an external voltage, an interface substrate 140 having a signal processing unit 142 for receiving a rectified voltage from the adaptor 120 and processing a signal, and an inverter 160 for receiving image information from the interface substrate 140, dropping a voltage to a predetermined voltage, and supplying it to the back light lamps 202.

Specifically, the adaptor 120 comprises an AC power input unit 210 for taking the external AC voltage, a first rectifying unit 220 for rectifying the AC voltage from the AC power input unit 210 into a DC voltage, a first converting unit 230 for converting the DC voltage rectified by the first rectifying unit 220, a second rectifying unit 240 for further rectifying the DC voltage from the first converting unit 230, an error detection/control-signal feedback circuit unit 250 for detecting an output voltage of the second rectifying unit 240 and stabilizing the output voltage according to a load, and a first power control unit 260 for receiving the stabilized output signal from the error detection/control-signal feedback circuit unit 250 and controlling the first converting unit 230.

The signal processing unit 142 of the interface substrate 140 comprises a DC converting unit 310 for receiving the rectified DC voltage from the second rectifying unit 240 of the adaptor 120 and converting it into a low voltage suitable for video signal processing, a noise removing circuit unit 320 for removing a noise from the rectified DC voltage from the second rectifying unit 240, an image signal processing unit 330 for receiving a low voltage from the DC converting unit 310 and processing the video signal, and a microcomputer 340 for controlling the image signal processing unit 330.

The inverter 160 comprises a second power control unit 410 for receiving the DC voltage without a noise from the noise removing circuit unit 320 and converting it to an AC voltage, a luminance adjusting circuit unit 420 for adjusting luminance under control of the microcomputer 340, a second converting unit 430 for receiving the AC voltage from the second power control unit 410 and converting it into a suitable voltage, an error detection/control-signal feedback circuit unit 440 for detecting the output voltage of the second converting unit 430 and stabilizing the output voltage according to a load, and a protecting circuit unit 450 for controlling overcurrent and overvoltage to be a proper level to protect the circuit.

In this liquid crystal display, however, the adaptor 120 has a complex appearance since it is designed to be exposed to the exterior and connected to the power line 110. The structure of the liquid crystal display is complex because the adaptor 120 is a separate entity.

In addition, the signal processing unit 142 of the interface substrate 140 must convert the DC voltage from the adaptor 120 into a low DC level (e.g., about 5V or less) required for operation of the image signal processing unit. This degrades conversion efficiency.

Furthermore, the above liquid crystal display is suitable in large size, but is not suitable as a small or middle-sized liquid crystal display having an LED module.

Recently, with the advent of various multimedia devices, such as image-communicable portable phones, MP3 players, portable multimedia players (PMPs), PDPs, personal digital assistants (PDAs), and electronic dictionaries, by virtue of technical development of electronic devices, the devices are gradually made small. Thus, there is a need for a liquid crystal display suitable for small multimedia devices.

### SUMMARY OF THE INVENTION

An aspect of the present invention provides a liquid crystal display comprising a driving circuit unit having an adaptor and an inverter integrally configured with each other.

Another aspect of the present invention provides a small or middle-sized liquid crystal display having an LED module in which a driving circuit unit for supplying a power voltage is integrally configured with the liquid crystal display in order to improve power efficiency.

Still another aspect of the present invention provides a liquid crystal display comprising a driving circuit unit in which the liquid crystal display comprises a power supply unit and an inverter, and an LCD module includes an LED module and an LED drive controlled by a timing control unit, which makes the liquid crystal display suitable as a small or middle-sized liquid crystal display.

To achieve the objects, a driving circuit unit comprising a power supply and an inverter integrally configured with each other is provided in an LCD module.

Exemplary embodiments of the present invention provide a liquid crystal display (LCD) comprising an LCD module, a back light disposed at one side of the LCD module for emitting light, and a driving circuit unit for driving the back light, and the driving circuit unit comprises: an AC power supply unit for supplying an external voltage; a first rectifying unit fro rectifying the external voltage from the AC power supply unit into a DC voltage; a first converting unit for converting the rectified DC voltage from the first rectifying unit; a second rectifying unit for further rectifying the converted voltage from the first converting unit; a DC converting unit for converting the rectified DC voltage from the second rectifying unit; an inverter power driving unit for receiving the converted current from the DC converting unit to drive an inverter; an inverter high-frequency driving circuit unit driven by the inverter power driving unit for driving a switching circuit and performing comparison, detection and control on an input voltage; a second converting unit for converting an output voltage of the inverter high-frequency driving circuit unit into a voltage having a predetermined level; an LCD module driven by a current from the second converting unit, LCD module including a timing control unit and an LED drive and being integrally configured with the back light; an image processing unit for processing a video signal using the DC converting unit driven by the rectified DC voltage from the second rectifying unit; and a microcomputer for receiving an image signal processed by the image processing unit and controlling luminance and the image signal.

The display may further comprise a protecting circuit unit for detecting an overvoltage output from the second converting unit to the back light to perform protection. The display may further comprise a noise removing circuit unit for performing comparison and detection on a voltage output from the second rectifying unit to the DC converting unit to remove a noise from the output voltage.

Other embodiments of the present invention provide a liquid crystal display comprising an LCD module having an LED module, a back light disposed at one side of the LCD module for emitting light, and a driving circuit unit for driving the back light, and the liquid crystal display comprises: the LCD module including a timing control unit connected to an LCD panel; and a graphic control unit connected to the timing control unit of the LCD module and having an LED drive integrally mounted therewith for driving the LED module.

Other embodiments of the present invention provide a liquid crystal display comprising an LCD module having an LED module, a back light disposed at one side of the LCD module for emitting light, and a driving circuit unit for driving the back light, and the liquid crystal display comprises: the LCD module including a timing control unit integrally configured with an LED drive and connected to an LCD panel; and a graphic control unit connected to the timing control unit of the LCD module for driving the timing control unit.

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a schematic view illustrating a structure of a conventional liquid crystal display;

FIG. 2 is a block diagram illustrating a conventional liquid crystal display;

FIG. 3 is an exploded perspective view illustrating a liquid crystal display comprising a driving circuit unit according to the present invention;

FIG. 4 is a schematic view illustrating a structure of a liquid crystal display comprising a driving circuit unit according to the present invention;

FIG. 5 is a block diagram illustrating a liquid crystal display comprising a driving circuit unit according to the present invention;

FIG. 6 is a block diagram illustrating a liquid crystal display comprising a driving circuit unit according to an embodiment of the present invention;

FIG. 7 is a circuit diagram illustrating an LED drive for a liquid crystal display according to the present invention;

FIG. 8 is a block diagram illustrating another embodiment of the present invention; and

FIG. 9 is a block diagram illustrating still another embodiment of the present invention.

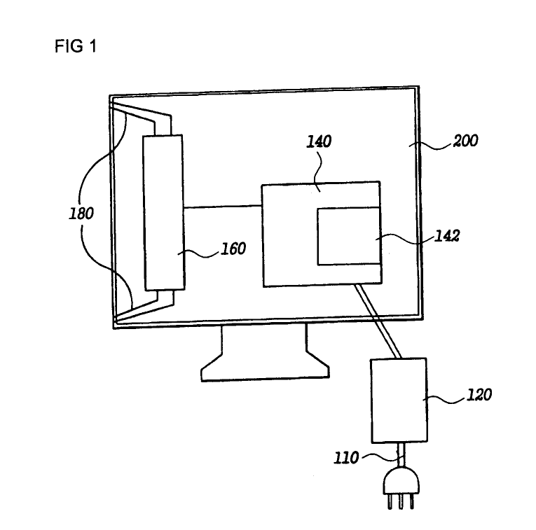

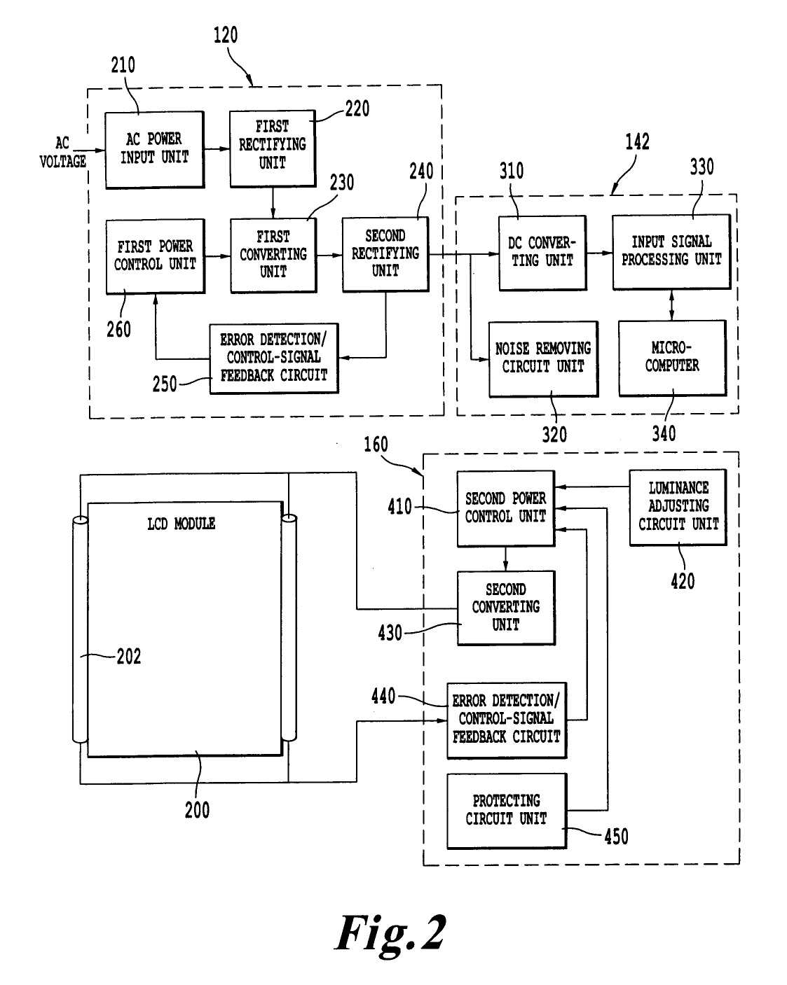

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided as teaching examples of the invention. Like numbers refer to like element.

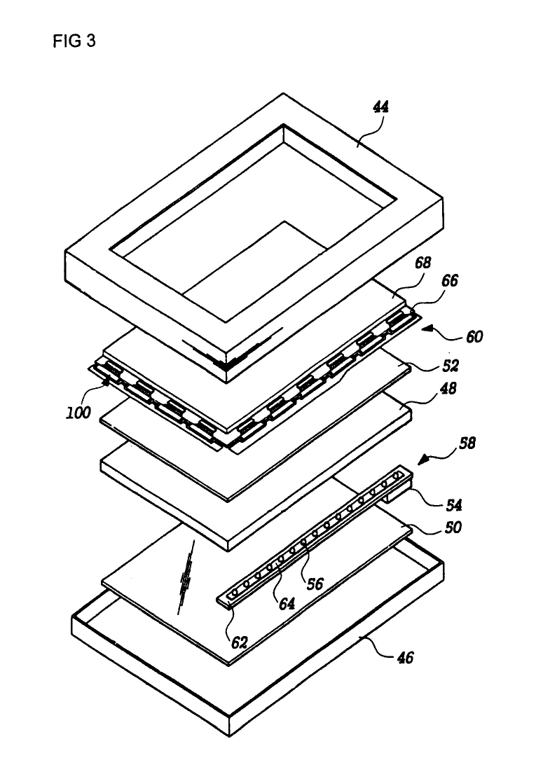

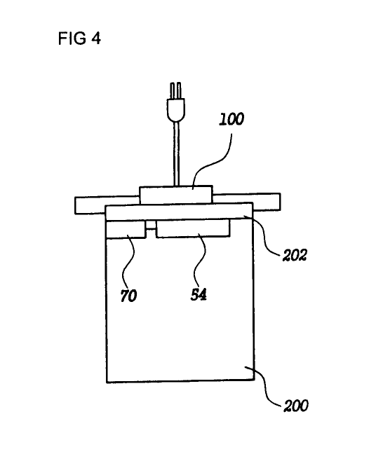

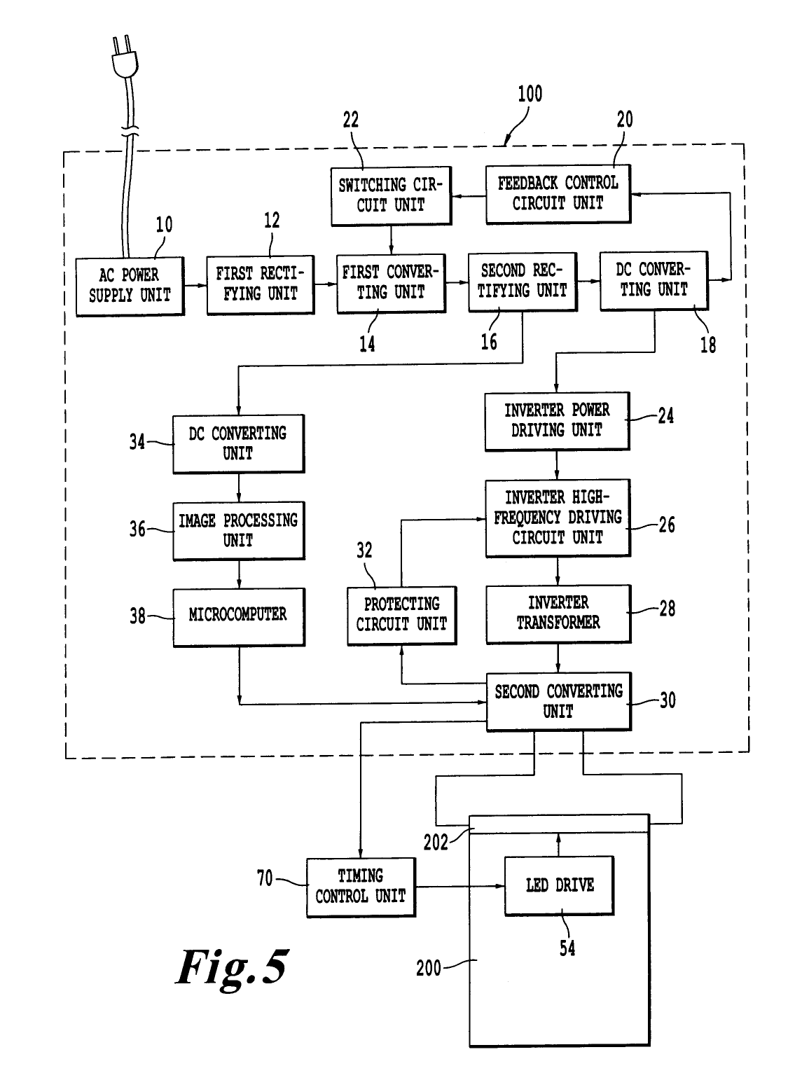

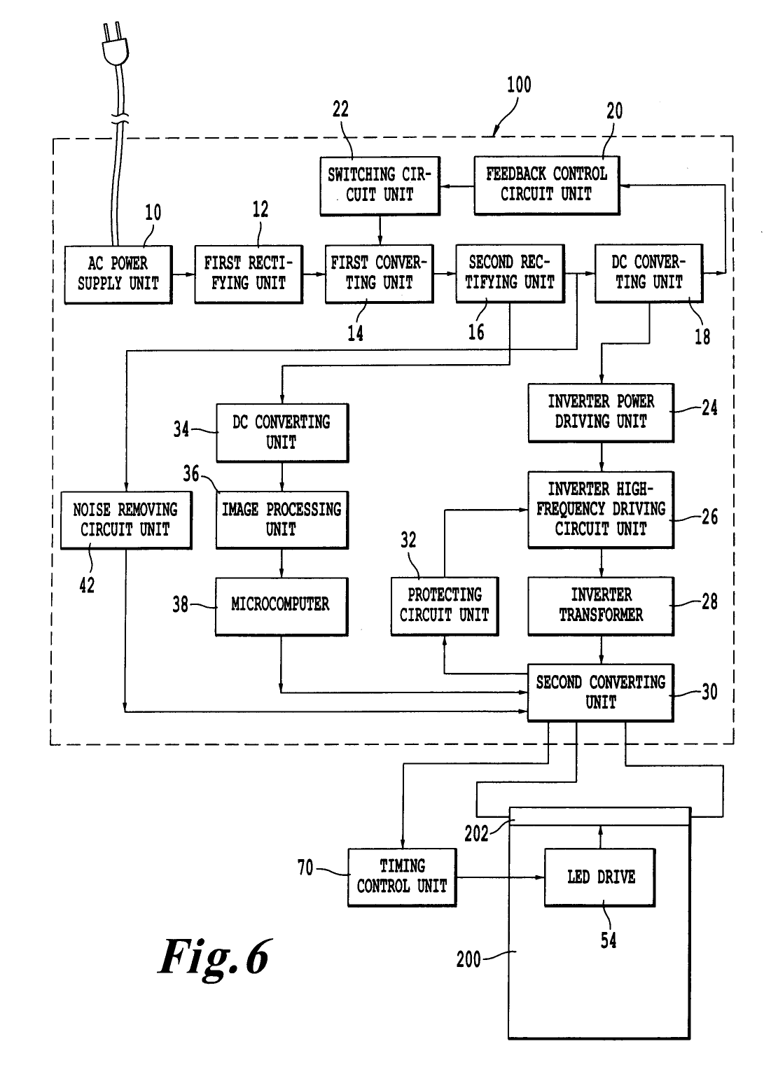

FIG. 3 is an exploded perspective view illustrating a liquid crystal display comprising a driving circuit unit according to the present invention, FIG. 4 is a schematic view illustrating a structure of a liquid crystal display comprising a driving circuit unit according to the present invention, FIG. 5 is a block diagram illustrating a liquid crystal display comprising a driving circuit unit according to the present invention, and FIG. 6 is a block diagram illustrating a liquid crystal display comprising a driving circuit unit according to an embodiment of the present invention.

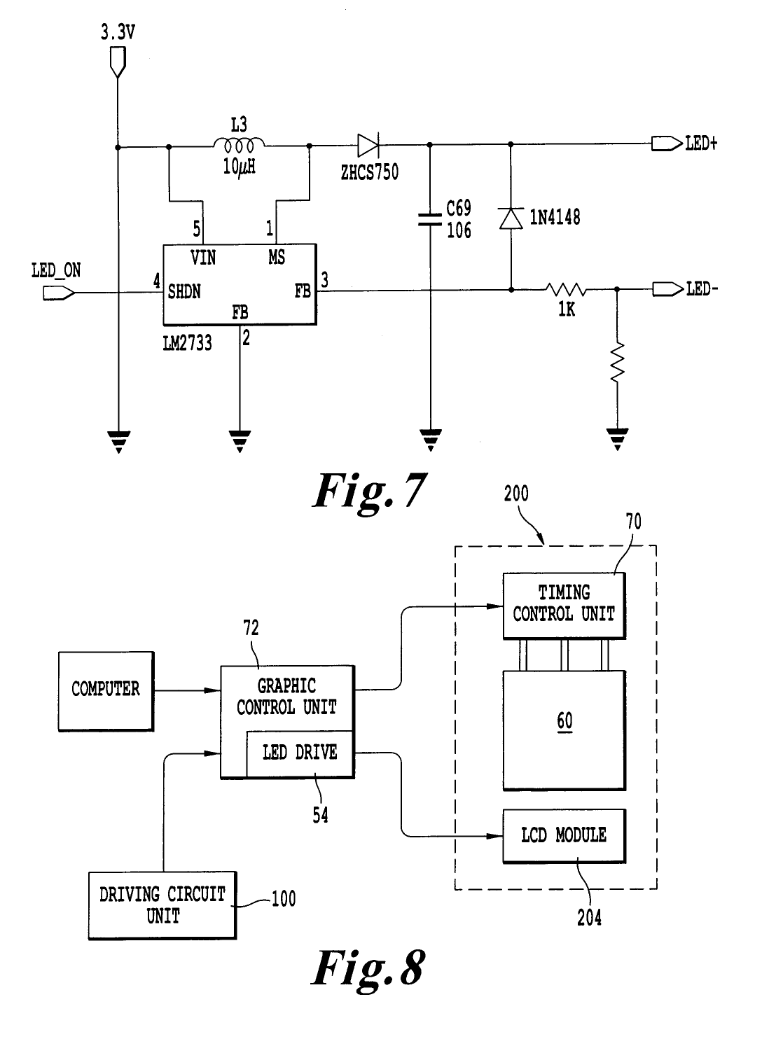

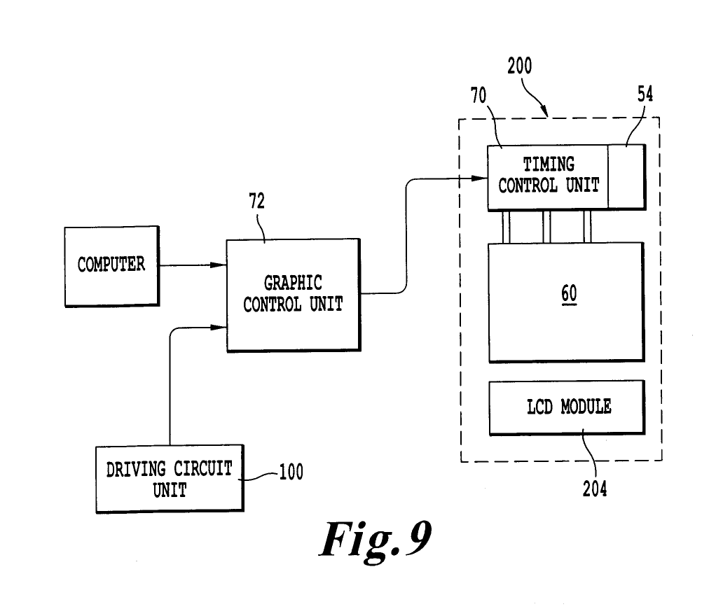

FIG. 7 is a circuit diagram illustrating an LED drive for a liquid crystal display according to the present invention, FIG. 8 is a block diagram illustrating another embodiment of the present invention, and FIG. 9 is a block diagram illustrating still another embodiment of the present invention.

Referring to FIG. 3, the liquid crystal display of the present invention comprises front and rear cases 44 and 46. The liquid crystal display further comprises an LCD panel 60 for displaying an image, and a back light 58 mounted below the LCD panel 60 for illuminating the LCD panel 60, both of which are interposed between the front and rear cases 44 and 46.

The liquid crystal display further comprises a light guide plate 48 disposed on the back light 58, and a diffusion sheet 52 disposed on the light guide plate 48. The LCD panel 60 is disposed on the diffusion sheet 52.

The liquid crystal display further comprises a reflection sheet 50 disposed below the light guide plate 48.

The back light 58 comprises a fixing plate 62 extending in a longitudinal direction and having a bar shape, an LED fixing PCB 64 fixed on the fixing plate 62, an LED drive 54 disposed at one side of a lower surface of the fixing plate 62, and a plurality of LED lamps 56 fixed on the LED fixing PCB 64.

The LCD panel 60 comprises a driving circuit unit 100 for supplying a voltage to the back light 58 and the LCD panel 60 to drive them.

The back light 58 having the above structure is disposed at a rear side of the light guide plate 48. Accordingly, the back light 58 can perform a back lighting function with a higher luminance.

The back light 58 comprises LED lamps 56, which are typical LED lamps for emitting white color light. Alternatively, the LED lamps 56 may include lamps that can emit white color light through a combination of red, blue, and green LEDs. The LED lamps 56 are driven by the LED drive 54.

The LED drive 54 is integrally configured with an LCD module 200 that will be described later, and is detachably connected to the digital LCD drive circuit. That is, the LED drive 54 is integrally configured with the back light 58, as in FIG. 4.

Accordingly, it is unnecessary to provide a separate LED drive circuit. What is needed is that an LCD panel control signal and an LED control signal are supplied to the driving circuit unit 100.

The LED drive 54 of the back light 58 is electrically controlled by a timing control unit 70 connected thereto.

Referring to FIGS. 4 to 6, the liquid crystal display according to the present invention further comprises a driving circuit unit 100 for converting a commercial AC voltage into a DC voltage and then into an AC voltage required for driving the back light 202. The driving circuit unit 100 is connected to the back light 202 for driving the back light 202. The back light 202 is electrically connected to the LCD module 200.

The driving circuit unit 100 comprises an AC power supply unit 10 for supplying a commercial AC voltage; a first rectifying unit 12 for rectifying the AC voltage from the AC power supply unit 10; a first converting unit 14 for converting the rectified DC voltage; a second rectifying unit 16 for further rectifying the DC voltage from the first converting unit 14; a DC converting unit 18 for detecting the rectified DC voltage from the second rectifying unit 16 and converting it into a voltage suitable for a load; a feedback control circuit unit 20 for detecting the voltage from the DC converting unit 18 and stabilizing it; and a switching circuit unit 22 for detecting a characteristic of the output voltage of the feedback control circuit unit 20, performing comparison on the voltage, and controlling a pulse width.

The driving circuit unit 100 further comprises an inverter power driving unit 24 driven by the DC voltage output from the DC converting unit 18; an inverter high-frequency driving circuit unit 26 for receiving the voltage from the inverter power driving unit 24 to drive the inverter, detecting and comparing the supplied DC voltage, and controlling the output voltage; an inverter transformer 28 driven by the output voltage of the inverter high-frequency driving circuit unit 26 for inducing a primary voltage toward a secondary side using magnetic induction of a core and a turn ratio of coils; and a second converting unit 30 for receiving the induced voltage from the inverter transformer 28 and further converting the DC voltage. The driving circuit unit 100 further comprises a protecting circuit unit 32 for controlling overcurrent and overvoltage output from the second converting unit 30 to be a suitable level in order to protect the circuit.

The inverter high-frequency driving circuit unit 24 comprises a control IC, a high-frequency control circuit, and a switching circuit for driving and controlling the inverter.

The high-frequency control circuit applies a switching signal to a switching circuit including a switching device such as one or a plurality of transistors or electric field transistors in order to switch the inverter transformer 28.

The second converting unit 30 is connected to the back light 202. The second converting unit 30 drives the back light 202 by supplying a high voltage to the back light 202.

The LCD module 200 integrally configured with the back light 202 comprises an LED drive 54, and a timing control unit 70 is connected to the LED drive 54.

Meanwhile, in order to process an image using a low voltage, the driving circuit unit 100 further comprises a DC converting unit 34 for receiving the DC voltage from the second rectifying unit 16; an image processing unit 36 for receiving a low DC voltage from the DC converting unit 34 and processing a video signal; and a microcomputer 38 for controlling the image processing unit 36.

The driving circuit unit 100 of the present invention drives the back light 202 and the LCD module 200.

FIG. 6 illustrates an embodiment of the present invention. The driving circuit unit 100 further comprises a luminance-adjusting circuit unit 40 for receiving the image-processed signal from the microcomputer 38 to adjust luminance of the liquid crystal display; and a noise removing circuit unit 42 for removing a noise from the DC voltage, which is sent from the second rectifying unit 16 to the DC converting unit 18.

In operation, first, the first rectifying unit 12 rectifies an AC voltage from the AC power supply unit 10 into a DC voltage, and the first converting unit 14 converts the DC voltage into a voltage having a predetermined level and inputs it to the second rectifying unit 16.

The second rectifying unit 16 further rectifies the DC voltage and inputs the resultant DC voltage to the DC converting unit 18.

The DC converting unit 18 converts the input voltage into a constant voltage for driving the inverter, and applies the constant voltage to the inverter power driving unit 24.

Meanwhile, the DC voltage from the second rectifying unit 16 is also input to the DC converting unit 34. The DC converting unit 34 outputs a typical, low constant voltage and inputs it to the image processing unit 36. Accordingly, the image processing unit 36 processes a video signal and drives the microcomputer 38.

As the output voltage of the DC converting unit 18 is applied to the inverter high-frequency driving circuit unit 26 via the inverter power driving unit 24, the inverter high-frequency driving circuit unit 26 operates to switch the inverter transformer 28.

The inverter transformer 28 induces the primary voltage toward a secondary voltage to stabilize the voltage, and applies the stabilized voltage to the second converting unit 30. The second converting unit 30 converts the voltage from the inverter transformer 28 into a high AC voltage required for driving the back light 202 and outputs the high AC voltage to drive the liquid crystal display.

The second converting unit 30 drives the timing control unit 70, which operates the LED drive 54 to drive the back light 202.

FIG. 7 is a circuit diagram illustrating an LED drive for a liquid crystal display according to the present invention, FIG. 8 is a block diagram illustrating another embodiment of the present invention, and FIG. 9 is a block diagram illustrating still another embodiment of the present invention.

Referring to FIGS. 8 to 9, a graphic control unit 72 is connected to a computer, and the graphic control unit 72 is connected to the LCD module 200.

The LCD module 200 comprises an LCD panel 60, a timing control unit 74 connected to the LCD panel 60, and an LED module 204 disposed at a side of the LCD panel 60.

The graphic control unit 72 is connected with the timing control unit 70.

As shown in FIG. 8, the LED drive 54 is provided in the graphic control unit 72, and the graphic control unit 72 is connected to the timing control unit 70.

The LED drive 54 is connected to the LED module 204 of the LCD module 200 for driving the LED module 204.

As shown in FIG. 9, the LED drive 54 of the present invention is provided in the timing control unit 70, and drives the LED module 204 as it is connected with the timing control unit 70.

According to the present invention, by providing the driving circuit unit comprising the power supply and the inverter integrally configured with each other in the LCD module, the liquid crystal display can be made small. The driving circuit unit can be easily applied to a small or middle-sized liquid crystal display, thereby preventing power loss.

According to the present invention, by providing the driving circuit unit comprising the power supply and the inverter integrally configured with each other in the LCD module, the liquid crystal display can be made small. The driving circuit unit can be easily disposed in a small or middle-sized liquid crystal display, thereby reducing manufacturing cost and the number of manufacture processes to improve productivity.

Furthermore, the present invention can be easily applied to a small or middle-sized liquid crystal display, which makes it possible to prevent power loss and efficiently supply the power.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A liquid crystal display (LCD) comprising an LCD module, a back light disposed at one side of the LCD module for emitting light, and a driving circuit unit for driving the back light, the driving circuit unit comprising:
an AC power supply unit for supplying an external voltage;
a first rectifying unit for rectifying the external voltage from the AC power supply unit into a DC voltage;
a first converting unit for converting the rectified DC voltage from the first rectifying unit;
a second rectifying unit for further rectifying the converted voltage from the first converting unit;
a DC converting unit for converting the rectified DC voltage from the second rectifying unit;
an inverter power driving unit for receiving a converted current from the DC converting unit to drive an inverter;
an inverter high-frequency driving circuit unit driven by the inverter power driving unit for driving a switching circuit and performing comparison, detection and control on an input voltage;
a second converting unit for converting an output voltage of the inverter high-frequency driving circuit unit into a voltage having a predetermined level;
the LCD module driven by a current from the second converting unit, LCD module including a timing control unit and an LED drive and being integrally configured with the back light;
an image processing unit for processing a video signal using the DC converting unit driven by the rectified DC voltage from the second rectifying unit; and
a microcomputer for receiving an image signal processed by the image processing unit and controlling luminance and the image signal.

2. The display according to claim 1, further comprising a protecting circuit unit for detecting an overvoltage output from the second converting unit to the back light to perform protection.

3. The display according to claim 1, further comprising a noise removing circuit unit for performing comparison and detection on an voltage output from the second rectifying unit to the DC converting unit to remove a noise from the output voltage.

4. A liquid crystal display comprising an LCD module having an LED module, a back light disposed at one side of the LCD module for emitting light, and a driving circuit unit for driving the back light, the liquid crystal display comprising:
the LCD module including a timing control unit connected to an LCD panel; and
a graphic control unit connected to the timing control unit of the LCD module and having an LED drive integrally mounted therewith for driving the LED module.

5. A liquid crystal display comprising an LCD module having an LED module, a back light disposed at one side of the LCD module for emitting light, and a driving circuit unit for driving the back light, the liquid crystal display comprising:
the LCD module including a timing control unit integrally configured with an LED drive and connected to an LCD panel; and
a graphic control unit connected to the timing control unit of the LCD module for driving the timing control unit.
